(19) United States
(12) Patent Application Publication
(10) Pub. No.: US 2026/0322828 A1
(43) Pub. Date: Oct. 15, 2026

(54) INFORMATION PROCESSING DEVICE, STORAGE MEDIUM, AND METHOD

(71) Applicant: KABUSHIKI KAISHA TOSHIBA, Kawasaki-shi Kanagawa (JP)

(72) Inventors: Kosuke TODA, Kawasaki Kanagawa (JP); Tomonori MAEDA, Kawasaki Kanagawa (JP); Fukutomo NAKANISHI, Sumida Tokyo (JP); Satoshi AOKI, Kawasaki Kanagawa (JP); Naoki OGURA, Kawasaki Kanagawa (JP)

(73) Assignee: KABUSHIKI KAISHA TOSHIBA, Kawasaki-shi Kanagawa (JP)

(21) Appl. No.: 19/462,357

(22) Filed: Jan. 28, 2026

(30) Foreign Application Priority Data
Jan. 30, 2025 (JP) 2025-013919

(51) Int. Cl. H04L 9/40

(52) U.S. Cl. CPC H04L 63/1416

(57) ABSTRACT

According to one embodiment, an information processing device generates a fourth communication packet for identifying a cause of a false positive detection occurring in the detection device, based on a second communication packet, which is part of a first communication packet that flowed through a monitored system monitored by the detection device upon operating one or more devices included in the monitored system, and a third communication packet that flowed through the monitored system as a result of routine communication performed in the monitored system. The information processing device identifies the cause of the false positive detection occurring in the detection device using the fourth communication packet and a list of alerts previously issued from the detection device.

### CROSS-REFERENCE TO RELATED APPLICATIONS

This application is based upon and claims the benefit of priority from Japanese Patent Application No. 2025-013919, filed Jan. 30, 2025, the entire contents of which are incorporated herein by reference.

### FIELD

Embodiments described herein relate generally to an information processing device, a storage medium, and a method.

### BACKGROUND

In a monitored system using an intrusion detection system (IDS) that detects cyberattacks, false positive detections sometimes occur in which operations within a normal operating range of the monitored system are erroneously recognized as anomalies. A large number of such false positive detections requires searching through many alerts to identify signs of an cyberattack, resulting in numerous unnecessary responses. Thus, effective and efficient security monitoring demands suppressing such false positive detections.

### BRIEF DESCRIPTION OF THE DRAWINGS

FIG. 1 is a schematic diagram showing a configuration example of a communication identification system including an information processing device according to one embodiment.

FIG. 2 is a schematic diagram showing a configuration example of a monitored system according to the same embodiment.

FIG. 3 is a block diagram showing a functional configuration example of the information processing device according to the same embodiment.

FIG. 4 shows an example of a data structure of an operation log according to the same embodiment.

FIG. 5 shows an example of a data structure of an operation-time communication packet according to the same embodiment.

FIG. 6 shows an example of a data structure of a steady-state communication packet according to the same embodiment.

FIG. 7 is a diagram for specifically describing a method of generating an operation-time-range packet according to the same embodiment.

FIG. 8 shows an example of a data structure of the operation-time-range packet according to the same embodiment.

FIG. 9 is a diagram for specifically describing a candidate packet generation process according to the same embodiment.

FIG. 10 is a diagram for specifically describing an evaluation communication packet generation process according to the same embodiment.

FIG. 11 shows an example of a data structure of detection result information according to the same embodiment.

FIG. 12 shows an example of a data structure of an alert list according to the same embodiment.

FIG. 13 shows an example of a data structure of an evaluation result packet group according to the same embodiment.

FIG. 14 is a diagram for specifically describing a process of deleting alerts from the alert list according to the same embodiment.

FIG. 15 shows a hardware configuration example of the information processing device according to the same embodiment.

FIG. 16 is a flowchart showing an example of a sequence of processes executed by the information processing device according to the same embodiment.

### DETAILED DESCRIPTION

In general, according to one embodiment, an information processing device is communicably connected to a detection device that detects cyberattacks and issues alerts. The information processing device comprises a candidate generation unit and a detection result analysis unit. The candidate generation unit generates a fourth communication packet for identifying a cause of a false positive detection occurring in the detection device, based on a second communication packet, which is part of a first communication packet that flowed through a monitored system monitored by the detection device upon operating one or more devices included in the monitored system and is presumed to correspond to an operation of the one or more devices, and a third communication packet that flowed through the monitored system as a result of routine communication performed in the monitored system. The detection result analysis unit compares a first alert, which was issued when the fourth communication packet is read by the detection device, with a list of alerts previously issued from the detection device during operations of the one or more devices and, when the first alert is included in the list, identifies the second communication packet used to generate the fourth communication packet read by the detection device as the cause of the false positive detection occurring in the detection device.

Embodiments will be described hereinafter with reference to the accompanying drawings.

Further, the disclosure is merely an example and, the invention is not limited by contents described in the embodiments described below. Modification which is easily conceivable by a person of ordinary skill in the art comes within the scope of the disclosure as a matter of course. In order to make the description clearer, the sizes, shapes and the like of the respective parts may be changed and illustrated schematically in the drawings as compared with those in an accurate representation. In a plurality of figures, constituent elements corresponding to each other are denoted by like reference numerals and their detailed descriptions may be omitted unless necessary.

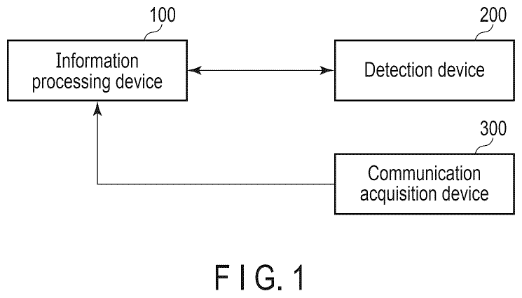

FIG. 1 is a schematic diagram showing a configuration example of a communication identification system including an information processing device according to one embodiment. As shown in FIG. 1, the communication identification system comprises an information processing device 100, a detection device 200, and a communication acquisition device 300.

The detection device 200 monitors a communication network including one or more devices, determines (detects) abnormal traffic based on communication data acquired from the communication network, and detects anomalies including cyberattacks. When detecting a cyberattack, the detection device 200 issues an alert indicating the occurrence. The communication network may be, for example, a local area network constructed using a wireless LAN or Ethernet. The present embodiment assumes that the detection device 200 is a network intrusion detection system (NIDS) capable of detecting cyberattacks. Alternatively, the detection device 200 may be another type of intrusion detection system (IDS), such as a host-based intrusion detection system (HIDS). In the following description, the communication network monitored by the detection device 200 is referred to as a “monitored system.”

The information processing device 100 identifies which operation and which corresponding communication within the monitored system caused a false positive detection. The information processing device 100 performs this identification to suppress the occurrence of false positive detections in which the detection device 200 erroneously determines an operation within a normal operating range of the monitored system as abnormal (in other words, the information processing device 100 performs this identification to suppress the issuance of false positive detections from the detection device 200. Accordingly, the information processing device 100 may also be referred to as a communication identification device.

The communication acquisition device 300 aims to acquire communication packets flowing through the monitored system. Such acquisition may be implemented, for example, by acquiring packets flowing through each device of the monitored system via a port mirroring function of a switching hub. The present embodiment describes cases where the communication acquisition device 300 and the detection device 200 are provided as separate devices. Alternatively, the detection device 200 may include the functions of the communication acquisition device 300.

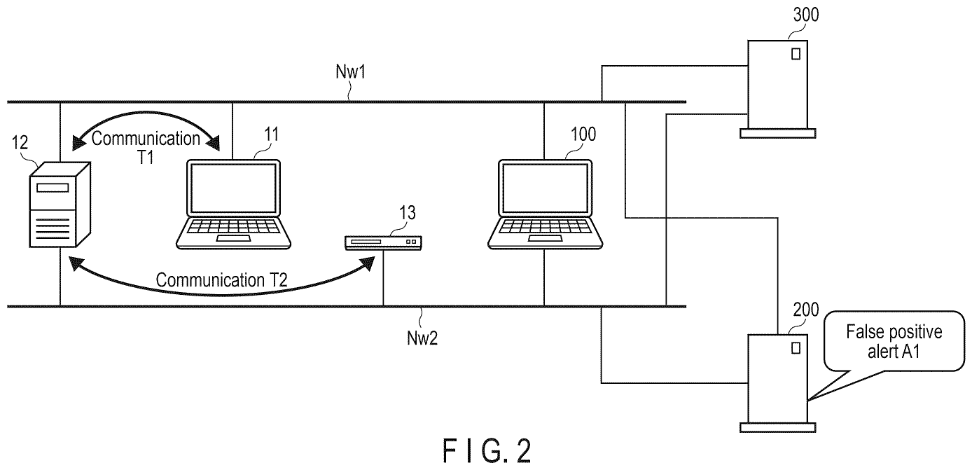

FIG. 2 is a schematic diagram showing a configuration example of the monitored system. As described above, the monitored system is a communication network monitored by the detection device 200. In FIG. 2, the monitored system corresponds to a local area network constructed of three devices (hosts) 11, 12, and 13, a network Nw1 that communicably connects the devices 11 and 12, and a network Nw2 that communicably connects the devices 12 and 13.

The number of the devices included in the monitored system is not limited to three (the devices 11, 12, and 13). Any number of devices may be included in the monitored system. The devices 11, 12, and 13 may be, for example, a personal computer (PC), a human-machine interface (HMI), or a programmable logic controller (PLC). The devices 11, 12, and 13 are not limited to these examples.

As one example, FIG. 2 shows a case where communications T1 and T2 respectively occur between the devices 11 and 12 and between the devices 12 and 13 when the device 11 is operated within a normal operating range and consequently the detection device 200 issues a false positive alert A1. In such a case, the information processing device 100 of the present embodiment identifies parameters such as a transmission source, a transmission destination, a port number, and a protocol of the communication corresponding to the operation when the false positive alert A1 was issued, and determines which communication caused the false positive alert A1.

More specifically, the information processing device 100 generates communication data (referred to later as an evaluation communication packet) corresponding to the operation at the time of issuance of the false positive alert A1 and used to identify its cause. This generation is performed using an operation log, in which operation histories of the devices 11, 12, and 13 included in the monitored system are recorded, and various communication packets acquired from the communication acquisition device 300 (a steady-state communication packet and an operation-time communication packet, both described later). Subsequently, the information processing device 100 causes the detection device 200 to read the generated communication data. Furthermore, the information processing device 100 repeatedly executes a process of comparing and analyzing the detection results acquired by such reading with an alert list including the false positive alert A1, thereby identifying the operation that caused the false positive alert A1 and the communication performed in response to the operation.

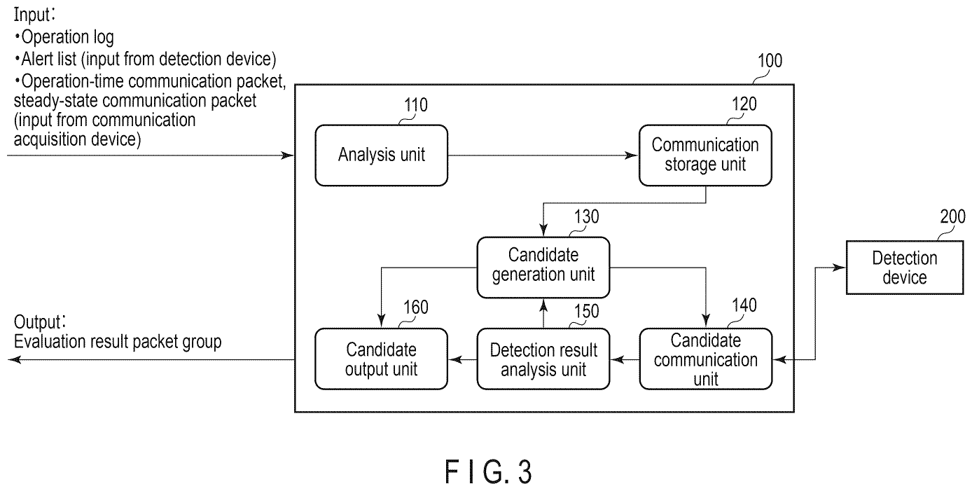

FIG. 3 is a block diagram showing a functional configuration example of the information processing device 100. As shown in FIG. 3, the information processing device 100 comprises an analysis unit 110, a communication storage unit 120, a candidate generation unit 130, a candidate communication unit 140, a detection result analysis unit 150, and a candidate output unit 160.

### Analysis Unit 110

The analysis unit 110 acquires an operation log 400 including operation histories of the devices 11, 12, and 13, from the devices 11, 12, and 13 included in the monitored system. For example, the analysis unit 110 acquires the operation log 400 from the devices 11, 12, and 13. Alternatively, the analysis unit 110 may acquire from an external terminal (not shown) located outside the monitored system the operation log 400 that is generated by an operator of the devices using the external terminal.

The analysis unit 110 also acquires a communication packet that flowed through the monitored system during operations of the devices 11, 12, and 13 (hereinafter referred to as an operation-time communication packet 500) from the communication acquisition device 300. The operation-time communication packet 500 includes both of a communication packet that flowed through the monitored system due to communications performed in response to the operations of the devices 11, 12, and 13 included in the monitored system (that is, a packet that flowed through the monitored system due to communications performed in response to specific operations corresponding to the operation log 400), and a communication packet that flowed due to communications routinely executed in the monitored system (hereinafter referred to as steady-state communication packets 600).

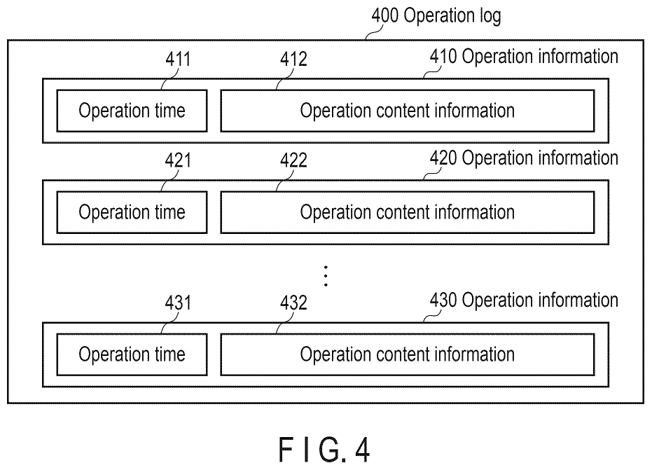

The following will describe data structures of the operation log 400, the operation-time communication packet 500, and the steady-state communication packet 600 in this order with reference to FIG. 4 to FIG. 6.

FIG. 4 shows an example of a data structure of the operation log 400. As shown in FIG. 4, the operation log 400 includes one or more pieces of operation information 410, 420, and 430. These pieces of operation information 410, 420, and 430 have the same data structure. Thus, the following will describe the data structure of the operation information 410 alone and omit explanations on the data structure of the operation information 420 and the operation information 430.

As shown in FIG. 4, the operation information 410 includes operation time 411 and operation content information 412. The operation time 411 indicates the time at which a specific device included in the monitored system was operated. The operation content information 412 indicates the content of the operation performed by that device included in the monitored system at the time indicated by the operation time 411. For example, the operation content information 412 may be a command history executed by the specific device. Alternately, the operation content information 412 may be a natural-language description of the operation performed by the specific device. The operation log 400 may be in JSON or XML format.

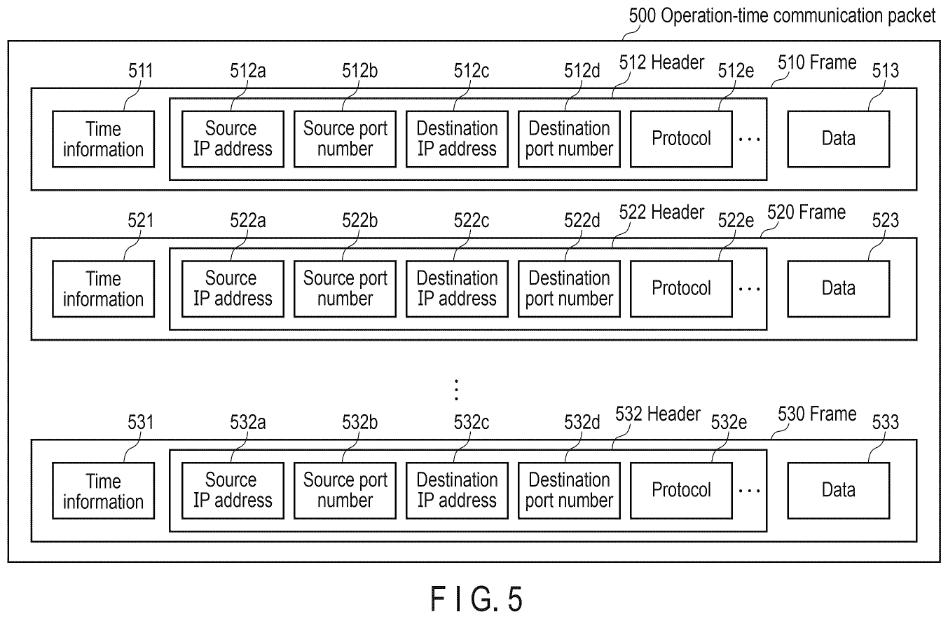

FIG. 5 shows an example of the data structure of the operation-time communication packet 500. As shown in FIG. 5, the operation-time communication packet 500 (the first communication packet) includes one or more frames 510, 520, and 530. The frames 510, 520, and 530 have the same data structure. Thus, the following will describe the data structure of the frame 510 alone and omit explanations on the data structure of the frames 520 and 530.

As shown in FIG. 5, the frame 510 includes time information 511, a header 512, and data 513.

The time information 511 indicates the time at which the frame 510 was transmitted.

The header 512 includes multiple types of information indicating the transmission sources and destinations of the frame 510, such as a source IP address 512a, a source port number 512b, a destination IP address 512c, a destination port number 512d, and a protocol 512e.

The source IP address 512a indicates the source IP address of the frame 510.

The source port number 512b indicates the source port number of the frame 510.

The destination IP address 512c indicates the destination IP address of the frame 510.

The destination port number 512d indicates the destination port number of the frame 510.

The protocol 512e indicates the communication protocol used for the transmission of the frame 510. For example, the protocol 512e may be a TCP (Transmission Control Protocol) or an UDP (User Datagram Protocol).

The data 513 is the body of data transmitted in the communication. For example, when the protocol 512e is the TCP, the data 513 may be a TCP payload. Alternatively, when the protocol 512e is the UDP, the data 513 may be an UDP payload.

The operation-time communication packet 500 may be in either PCAP or PCAPNG format.

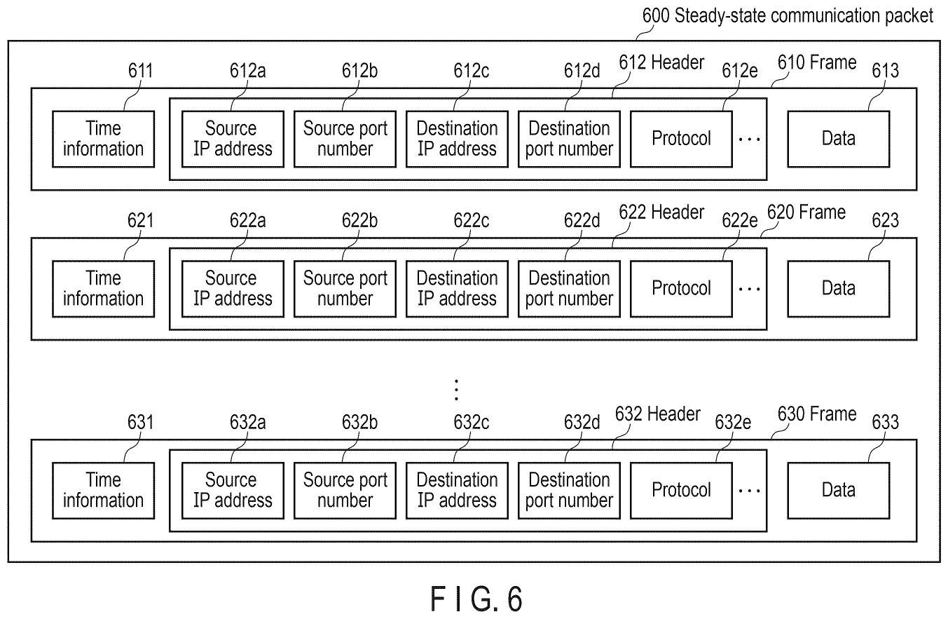

FIG. 6 shows an example of a data structure of the steady-state communication packet 600. As shown in FIG. 6, the steady-state communication packet 600 (the third communication packet) includes one or more frames 610, 620, and 630. The frames 610, 620, and 630 have the same data structure. Thus, the following will describe the data structure of the frame 610 alone and omit explanations on the data structure of the frames 620 and 630.

As shown in FIG. 6, the frame 610 includes time information 611, a header 612, and data 613.

The time information 611 indicates the time at which the frame 610 was transmitted.

The header 612 includes multiple types of information indicating the transmission sources and destinations of the frame 610, such as a source IP address 612a, a source port number 612b, a destination IP address 612c, a destination port number 612d, and a protocol 612e.

The source IP address 612a indicates the source IP address of the frame 610.

The source port number 612b indicates the source port number of the frame 610.

The destination IP address 612c indicates the destination IP address of the frame 610.

The destination port number 612d indicates the destination port number of the frame 610.

The protocol 612e indicates the communication protocol used for the transmission of the frame 610. For example, the protocol 612e may be the TCP or the UDP.

The data 613 is the body of data transmitted in the communication. When the protocol 612e is the TCP, the data 613 may be the TCP payload. Alternatively, when the protocol 612e is the UDP, the data 613 may be the UDP payload.

The steady-state communication packet 600 may be in PCAP or PCAPNG format.

The following will describe the analysis unit 110 again.

The analysis unit 110 generates a communication packet that flowed through the monitored system around an operation time recorded in the operation log 400 (hereinafter referred to as an operation-time-range packet 500′) based on the acquired operation log 400 and the acquired operation-time communication packet 500.

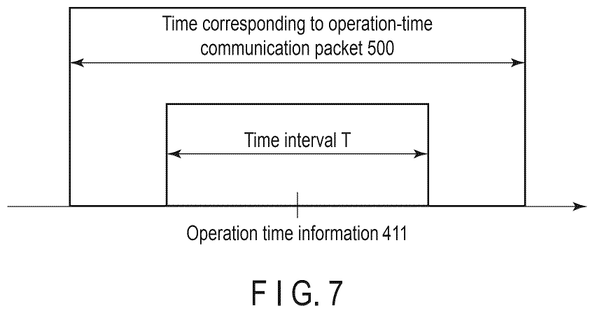

The following will describe a method of generating the operation-time-range packet 500′ with reference to FIG. 7. The example in FIG. 7 assumes that the analysis unit 110 generates the operation-time-range packet 500′ corresponding to the operation information 410 included in the operation log 400.

In this case, the analysis unit 110 defines an arbitrary time interval T including the operation time 411 included in the operation information 410 as shown in FIG. 7. Further, the analysis unit 110 cuts out (extracts) all frames whose time information falls within the time interval T from the operation-time communication packet 500. The analysis unit 110 performs this extraction to generate the operation-time-range packet 500′ corresponding to the operation information 410. When the analysis unit 110 can also acquire information indicating an end time of an operation corresponding to the operation information 410 (an operation end time) and calculate a time period from the operation time 411 (an operation start time) to the operation end time, the interval T may be defined as a time period that starts at a time obtained by tracking back from the operation start time 411 by the calculated time and ends at the operation end time. Setting the interval T to start at the time obtained by tracking back from the operation start time 411 by the calculated time allows the system to address cases where time alignment fails between operation time 411 in the operation information 410 (the operation log 400) and time information in the operation-time communication packet 500.

The above described the case where the analysis unit 110 generates the operation-time-range packet 500′ corresponding to the operation information 410. The analysis unit 110 uses the same procedure to generate the operation-time-range packets 500′ corresponding to the other operation information 420 and 430. The operation-time-range packet 500′ generated is stored in the communication storage unit 120.

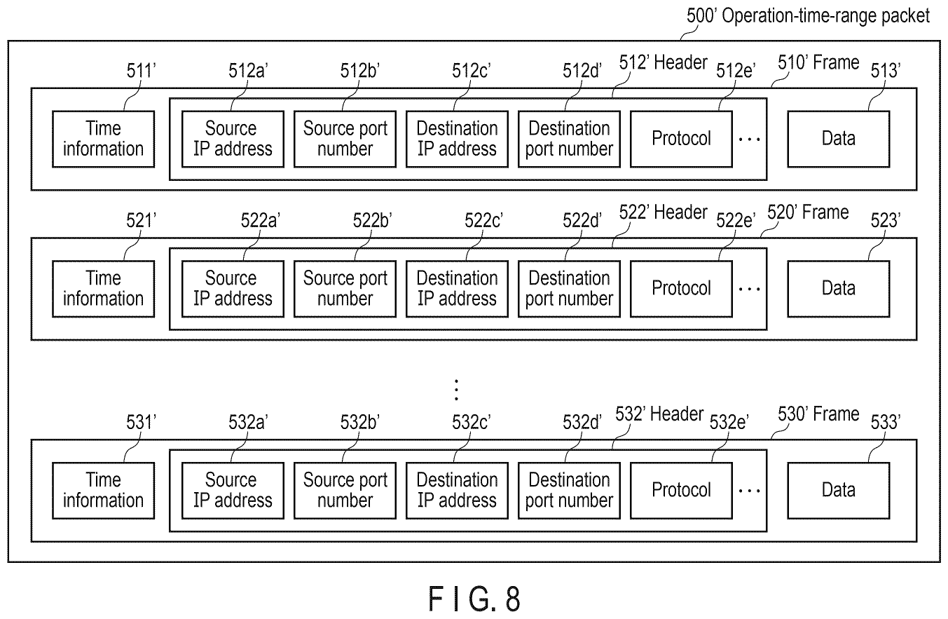

FIG. 8 shows an example of a data structure of the operation-time-range packet 500′. As described above, the operation-time-range packet 500′ (the fifth communication packet) is generated by cutting out part of the operation-time communication packet 500. Thus, one or more frames included in the operation-time-range packet 500′ are included in the operation-time communication packet 500 as well. That is, the operation-time-range packet 500′ and the operation-time communication packet 500 have the same data structure. Thus, the following will not describe the data structure of the operation-time-range packet 500′ in detail.

### Communication Storage Unit 120

The communication storage unit 120 stores both the steady-state communication packet 600 acquired by the analysis unit 110 and the operation-time-range packet 500′ generated by the analysis unit 110.

### Candidate Generation Unit 130

The candidate generation unit 130 synthesizes part of the steady-state communication packet 600 and the operation-time-range packet 500′ stored in the communication storage unit 120 to generate an evaluation communication packet 700. More specifically, the candidate generation unit 130 executes two processes: (1) a candidate packet generation process, in which part of the operation-time-range packet 500′ stored in the communication storage unit 120 is cut out (extracted) to generate a candidate packet 500″; and (2) an evaluation packet generation process, in which the steady-state communication packet 600 stored in the communication storage unit 120 and the candidate packet 500″ generated are combined to generate the evaluation communication packet 700. The evaluation communication packet 700 is used to identify (evaluate and verify) which operation and communication within the monitored system correspond to a false positive alert issued from the detection device 200. The following will describe the candidate packet generation process and the evaluation communication packet generation process in detail.

First, the following will describe the candidate packet generation process.

The candidate generation unit 130 focuses on one of the one or more frames included in the operation-time-range packet 500′ stored in the communication storage unit 120 and extracts all of the one or more frames having the same protocol as that included in the header of the focused frame from the operation-time-range packet 500′. Then, among the one or more extracted frames, the candidate generation unit 130 further extracts frames whose source IP address, source port number, destination IP address, and destination port number have values respectively identical to those included in the header of the focused frame. Similarly, the candidate generation unit 130 further extracts, from the extracted one or more frames, one or more frames whose destination IP address and destination port number have values respectively identical to those of the source IP address and the source port number included in the header of the focused frame and whose source IP address and source port number have values respectively identical to those of the destination IP address and the destination port number included in the header of the noted frame. These processes generate the candidate pocket 500″ (the second communication packet).

The candidate generation unit 130 redefines the remaining frames in the operation-time-range packet 500′ after extracting the candidate packet 500″ as the new operation-time-range packet 500′.

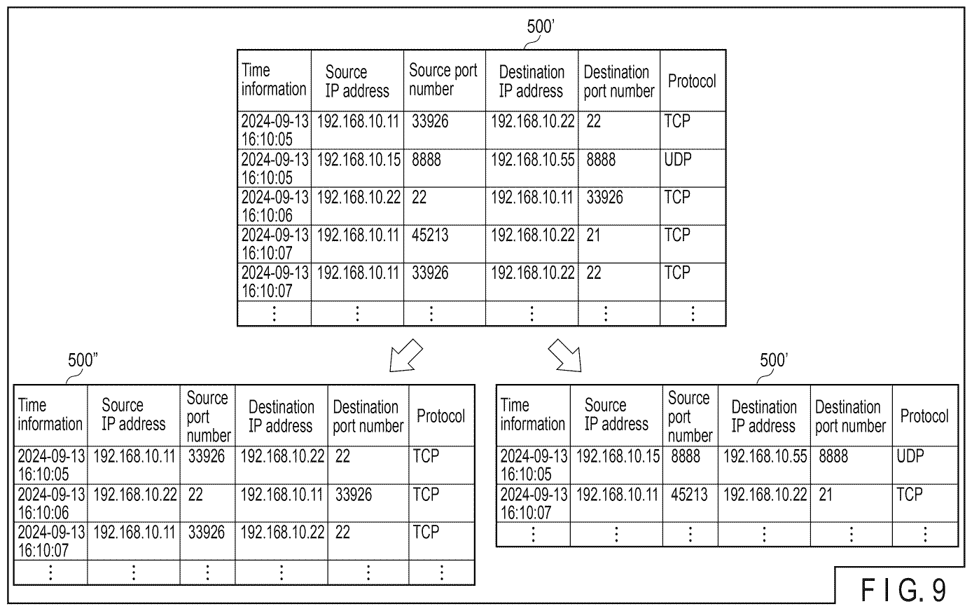

FIG. 9 is a diagram for specifically describing the candidate packet generation process.

The upper figure in FIG. 9 indicates the one or more frames included in the operation-time-range packet 500′. The lower left figure in FIG. 9 indicates one or more frames included in the candidate pocket 500″. The lower right figure in FIG. 9 indicates the one or more frames included in the new operation-time-range packet 500′. The one or more frames included in the operation-time-range packet 500′ shown in the upper figure in FIG. 9, the one or more frames included in the candidate pocket 500″ shown in the lower left figure in FIG. 9, and the one or more frames included in the new operation-time-range packet 500′ shown in the lower right figure in FIG. 9 are assumed to be arranged in the ascending order with respect to the time indicated by the time information. The one or more frames included in each packet may be arranged in other order such as in the descending order with respect to the time indicated by the time information.

As shown in the upper figure in FIG. 9, the following assumes that the operation-time-range packet 500′ stored in the communication storage unit 120 has five frames. The following assumes that the candidate generation unit 130 focuses on a head frame (the first-row frame) from the five frames included in the operation-time-range packet 500′ and arranged in the ascending order with respect to the time indicated by the time information. This focused first-row frame has a time indicated by the time information of “2024-09-13 16:10:05”, the source IP address of “192.168.10.11”, the source port number “33926”, the destination IP address “192.168.10.22”, the destination port number “22”, and the protocol “TCP”. The following assumes that the candidate generation unit 130 focuses on the head frame. The candidate generation unit 130 may focus on other frames.

In that case, the candidate generation unit 130 first extracts the frames indicating “TCP” protocol from the five frames included in the operation-time-range packet 500′ (in this case, the frames in the first row and the third to fifth rows shown in the upper figure in FIG. 9). Next, the candidate generation unit 130, from the frames indicating the protocol as “TCP”, extracts the frames whose source IP address, source port number, destination IP address, and destination port number respectively are “192.168.10.11”, “33926”, “192.168.10.22”, and “22” (in this case, the frames in the first and fifth rows shown in the upper figure in FIG. 9), and frames whose source IP address and source port number are respectively “192.168.10.22” and “22” (i.e., the destination IP address and the destination port number of the focused frame), and whose destination IP address and destination port number are respectively “192.168.10.11” and “33926” (i.e., the source IP address and the source port number of the focused frame) (in this case, the frame in the third row of the upper figure in FIG. 9). This extraction generates the candidate packet 500″ shown in the lower left figure in FIG. 9.

After extracting the candidate packet 500″, the candidate generation unit 130 redefines the operation-time-range packet 500′ including remaining two frames (in this case, the frames shown in the second and fourth rows of the upper figure in FIG. 9) as the new operation-time-range packet 500′ as shown in the lower right figure in FIG. 9.

The candidate packet generation process described above enables the generation of candidate packet 500″ including one or more frames presumed to correspond to communications performed in response to the operation of the devices 11, 12, and 13 included in the monitored system, among one or more frames included in the packet 500″.

Next, the following will describe the evaluation communication packet generation process.

The candidate generation unit 130 modifies time information of the candidate packet 500″ generated by the candidate packet generation process and time information of the steady-state communication packet 600 stored in the communication storage unit 120 and then synthesizes (combines) the candidate packet 500″ and the steady-state communication packet 600 each having the time information modified to generate the evaluation communication packet 700 (the fourth communication packet).

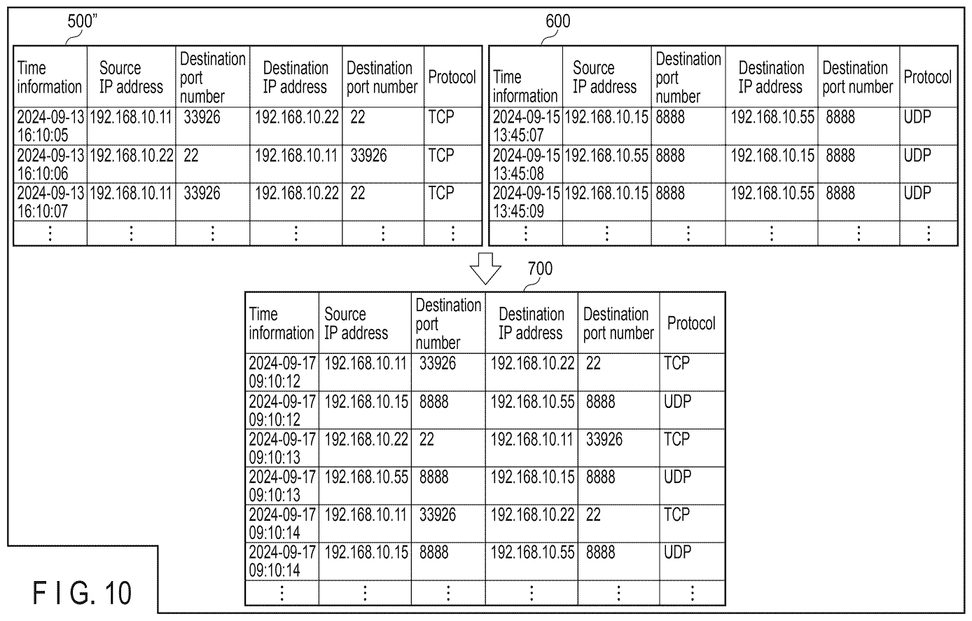

FIG. 10 is a diagram for specifically describing the evaluation communication packet generation process.

The upper left figure in FIG. 10 indicates one or more frames included in the candidate pocket 500″. The upper right figure in FIG. 10 shows the one or more frames included in the steady-state communication packet 600. The lower figure in FIG. 10 shows one or more frames included in the evaluation communication packet 700. The one or more frames included in the candidate packet 500″ shown in the upper left figure in FIG. 10, the one or more frames included in the steady-state communication packet 600 shown in the upper right figure in FIG. 10, and the one or more frames included in the evaluation communication packet 700 shown in the lower figure in FIG. 10 are assumed to be arranged in ascending order with respect to the time indicated by the time information.

In this case, the candidate generation unit 130 changes (shifts) the time “2024-09-13 16:10:05”, which is the time indicated by the time information of the head (the first row) frame among the three frames included in the candidate packet 500″ shown in the upper left figure in FIG. 10, and the time “2024-09-15 13:45:07”, which is indicated by the time information of the head (the first row) frame among the three frames included in the steady-state communication packet 600 shown in the upper right figure in FIG. 10 to the current time “2024-09-17 09:10:12”.

Furthermore, the candidate generation unit 130 changes the times respectively indicated by the time information of the remaining two frames included in the candidate packet 500″ shown in the upper left figure in FIG. 10 (in this case, the frames shown in the second and third rows of the upper left figure in FIG. 10) such that these times involve no contradictions. Specifically, the candidate generation unit 130 first calculates the difference (a time interval) between the time indicated by the time information of the head frame shown in the upper left figure in FIG. 10 and the time indicated by the time information of the second-row frame shown in the upper left figure in FIG. 10. Then, in the evaluation communication packet 700 as well, the candidate generation unit 130 changes the time indicated by the time information of the second-row frame shown in the upper left figure in FIG. 10 such that the time interval between the time indicated by the time information of the frame corresponding to the first-row frame shown in the upper left figure in FIG. 10 (the head frame in the lower figure in FIG. 10) and the time indicated by the time information of the frame corresponding to the second-row frame shown in the upper left figure in FIG. 10 (the third-row frame in the lower figure in FIG. 10) corresponds to the calculated the time interval.

Similarly, the candidate generation unit 130 first calculates the difference (a time interval) between the time indicated by the time information of the head frame shown in the upper left figure in FIG. 10 and the time indicated by the time information of the third-row frame shown in the upper left figure in FIG. 10. Then, in the evaluation communication packet 700 as well, the candidate generation unit 130 changes the time indicated by the time information of the third-row frame shown in the upper left figure in FIG. 10 such that the time interval between the time indicated by the time information of the frame corresponding to the head frame shown in the upper left figure in FIG. 10 (the head frame in the lower figure in FIG. 10) and the time indicated by the time information of the frame corresponding to the third-row frame shown in the upper left figure in FIG. 10 (the fifth-row frame in the lower figure in FIG. 10) corresponds to the calculated the time interval.

Furthermore, the candidate generation unit 130 changes the times respectively indicated by the time information of the remaining two frames included in the steady-state communication packet 600 shown in the upper right figure in FIG. 10 (in this case, the frames shown in the second and third rows of the upper right figure in FIG. 10) such that these times involve no contradictions. Specifically, the candidate generation unit 130 first calculates the difference (a time interval) between the time indicated by the time information of the head frame shown in the upper right figure in FIG. 10 and the time indicated by the time information of the second-row frame shown in the upper right figure in FIG. 10. Then, in the evaluation communication packet 700 as well, the candidate generation unit 130 changes the time indicated by the time information of the second-row frame shown in the upper right figure in FIG. 10 such that the time interval between the time indicated by the time information of the frame (the second-row frame in the lower figure in FIG. 10) corresponding to the first-row frame shown in the upper right figure in FIG. 10 and the time indicated by the time information of the frame (the fourth-row frame in the lower figure in FIG. 10) corresponding to the second-row frame shown in the upper right figure in FIG. 10 corresponds to the calculated the time interval.

Similarly, the candidate generation unit 130 first calculates the difference (a time interval) between the time indicated by the time information of the head frame shown in the upper right figure in FIG. 10 and the time indicated by the time information of the third-row frame shown in the upper right figure in FIG. 10. Then, in the evaluation communication packet 700 as well, the candidate generation unit 130 changes the time indicated by the time information of the third-row frame shown in the upper right figure in FIG. 10 such that the time interval between the time indicated by the time information of the frame (the second-row frame in the lower figure in FIG. 10) corresponding to the head frame shown in the upper right figure in FIG. 10 and the time indicated by the time information of the frame (the sixth-row frame in the lower figure in FIG. 10) corresponding to the third-row frame shown in the upper right figure in FIG. 10 corresponds to the calculated the time interval.

The candidate generation unit 130 synthesizes (combines) the candidate packet 500″ including three frames with the modified time information and the steady-state communication packet 600 including three frames with the modified time information by sorting them in the ascending order with respect to the time indicated by the time information, thereby generating the evaluation communication packet 700 as shown in the lower figure in FIG. 10.

The evaluation communication packet generation process described above enables adaptation to specifications and settings of the detection device 200 that issues alerts when a certain amount of communication volume is observed and communication data corresponding to a specific operation is received. For example, depending on specifications and settings of the detection device 200, merely receiving communication data corresponding to a specific operation might not issue an alert unless a certain amount of communication volume is observed. In such cases, merely causing the detection device 200 to read communication data corresponding to a specific operation may not reproduce the alert. Executing the above evaluation communication packet generation process enables the generation of the evaluation communication packet 700 that also accommodates the above specifications and settings.

### Candidate Communication Unit 140

The candidate communication unit 140 transmits the evaluation communication packet 700 generated by the candidate generation unit 130 for the detection device 200 to read it. At this time, the detection device 200 may be connected to the monitored system or separated from it. That is, the detection device 200 may be integrated into the local area network (physical environment), which is the monitored system, or separated from it.

When the detection device 200 reads the evaluation communication packet 700 and issues one or more alerts, the detection device 200 transmits detection result information 800 indicative of details of those alerts to the candidate communication unit 140. In this case, the candidate communication unit 140 receives the detection result information 800 from the detection device 200 and outputs the received detection result information 800 to the detection result analysis unit 150.

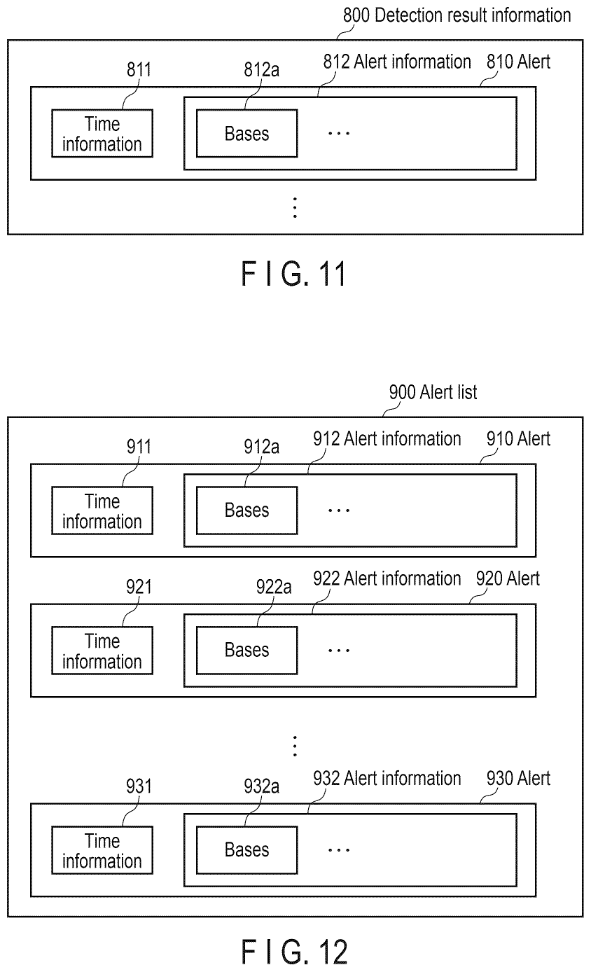

The following will describe the data structure of the detection result information 800 with reference to FIG. 11.

FIG. 11 shows an example of the data structure of the detection result information 800. As shown in FIG. 11, the detection result information 800 includes an alert 810 issued by the detection device 200. The data structure of the alert 810 varies depending on the specifications and settings of the detection device 200. Any alert issued from any detection device 200 includes at least time information 811 and alert information 812.

For example, the time information 811 indicates the time at which the detection device 200 issued the alert. The alert information 812 relates to the alert issued at the time indicated by time information 811 and further includes one or more bases 812a. Although detailed description is omitted here, the alert information 812 may further include, besides the bases 812a, a score or a classification of the alert.

The bases 812a indicate the cause of the alert (that is, the bases on which the alert was issued). For example, the bases 812a may be the signature used at the time of issuance of the alert. Alternatively, the bases 812a may be information about the frame that caused the alert and is included in the evaluation communication packet 700 (for example, information indicating the time information, the source IP address, the source port number, the destination IP address, the destination port number, and the protocol included in the frame).

The above assumes that the time information 811 included in the alert 810 indicates the time at which the detection device 200 issued the alert. Depending on the specifications or settings of the detection device 200, the time information 811 may indicate a time indicated by the time information of the frame that caused the alert and is included in the evaluation communication packet 700, rather than the time at which the alert was issued. In this case, the bases 812a included in the alert information 812 may indicate, as information about the frame that caused the alert and is included in the evaluation communication packet 700, information other than the time information included in that frame (that is, the bases 812a may indicate information indicating the source IP address, the source port number, the destination IP address, the destination port number, and the protocol).

### Detection Result Analysis Unit 150

When the detection result analysis unit 150 receives the detection result information 800 from the candidate communication unit 140, the detection result analysis unit 150 compares the received detection result information 800 with an alert list 900 acquired from the detection device 200.

The following will describe an example of the data structure of the alert list 900 with reference to FIG. 12.

FIG. 12 shows an example of the data structure of the alert list 900. The alert list 900 includes one or more alerts 910, 920, and 930 that have been previously issued by the detection device 200. The information processing device 100 of the present embodiment operates when a false positive alert is issued by the detection device 200. At least one of the alerts 910, 920, and 930 in the alert list 900 is a false positive alert. The alerts 910, 920, and 930 have the same data structure. Thus, the following will describe the data structure of the alert 910 alone and omit explanations on the data structure of the alerts 920 and 930.

As shown in FIG. 12, the alert 910 includes time information 911 and alert information 912. For example, the time information 911 indicates the time at which the detection device 200 issued the alert. The alert information 912 about the alert issued at the time indicated by time information 911 and further includes one or more bases 912a. Although detailed description is omitted here, the alert information 912 may further include, besides the bases 912a, a score or a classification of the alert.

The bases 912a indicate the cause of the alert (that is, the bases on which the alert was issued). For example, the bases 912a may be the signature used at the time of issuance of the alert. Alternatively, the bases 912a may be information about the frame that caused the alert (for example, information indicating the time information, the source IP address, the source port number, the destination IP address, the destination port number, and the protocol included in the frame).

The above assumes that the time information 911 included in the alert 910 indicates the time at which the detection device 200 issued the alert. Depending on the specifications or settings of the detection device 200, the time information 911 may indicate a time indicated by the time information of the frame that caused the alert, rather than the time at which the alert was issued. In this case, the bases 912a included in the alert information 912 may indicate, as information about the frame that caused the alert, information other than the time information included in that frame (that is, the base 912a may indicate information indicating the source IP address, the source port number, the destination IP address, the destination port number, and the protocol).

The following will describe the detection result analysis unit 150 again.

As described above, the detection result analysis unit 150 compares the detection result information 800 with the alert list 900 to determine whether an alert included in the detection result information 800 (for example, the alert 810) is also included in the alert list 900. More specifically, the detection result analysis unit 150 determines whether the alert including the alert information corresponding to the alert information of the alert included in the detection result information 800 (for example, the alert information 812) is included in the alert list 900. The detection result analysis unit 150 determines whether the alert information of the alert included in the detection result information 800 corresponds to the alert information of the alert included in the alert list 900 match, for example, based on whether the bases included in the alert information match.

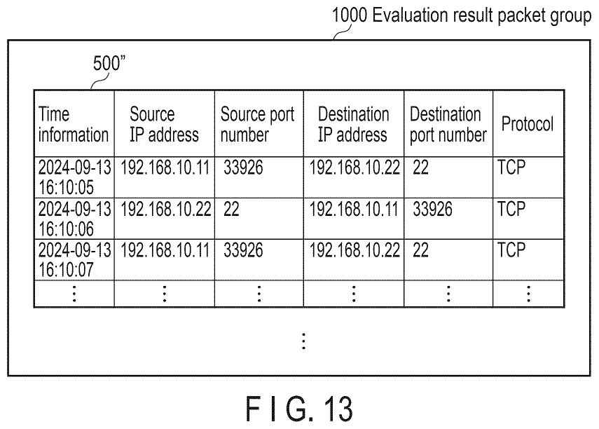

When the detection result analysis unit 150 determines that the alert included in the detection result information 800 is included in the alert list 900 as well, the detection result analysis unit 150 adds the candidate packet 500″, which was used to generate the evaluation communication packet 700 read by the detection device 200 to reproduce that alert, to an evaluation result packet group 1000. Through this process, one or more candidate packets 500″ each including one or more frames identified as corresponding to communications performed in response to the operations of the devices 11, 12, and 13 in the monitored system can be extracted (or collected) as the evaluation result packet group 1000, as shown in FIG. 13.

The detection result analysis unit 150 also deletes any alert that is included in the alert list 900 and matches the alert included in the detection result information 800 from the alert list 900. Then, the detection result analysis unit 150 redefines the alert list 900 after deletion as a new alert list 900.

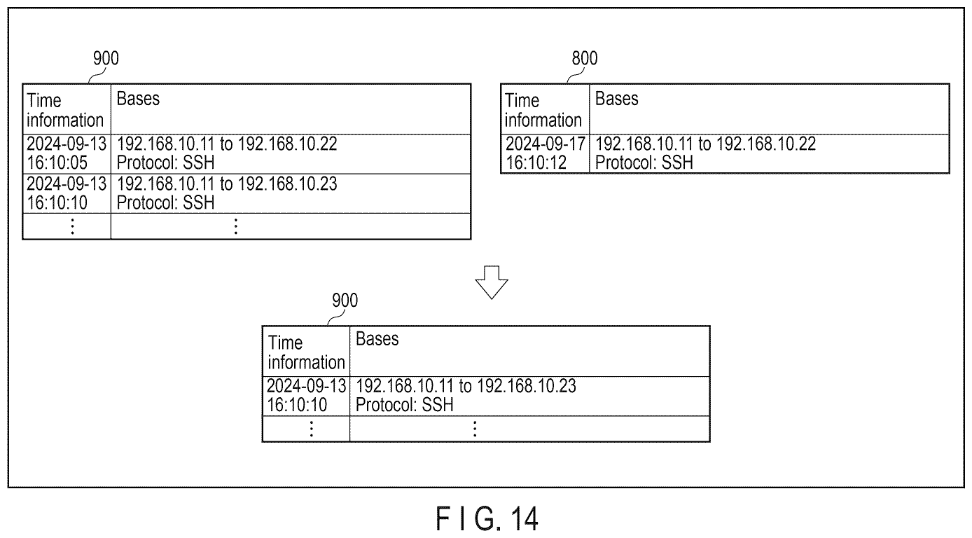

FIG. 14 specifically describes the process of deleting the alerts that match the alert included in the detection result information 800 from the alert list 900. In this case, the detection result analysis unit 150 deletes, from the alert list 900, the alert that is included in the alert list 900 shown in the upper left figure in FIG. 14 and matches the alert included in the detection result information 800 shown in the upper right figure in FIG. 14. That is, the detection result analysis unit 150 deletes the alert including a base “192.168.10.11 to 192.168.10.22” from the alert list 900 and redefines a new alert list 900 through this process.

The detection result analysis unit 150 repeatedly executes this sequence of processes for all of the one or more alerts included in the detection result information 800. The evaluation result packet group 1000 collected by the detection result analysis unit 150 is then output to the candidate output unit 160.

### Candidate Output Unit 160

When the candidate output unit 160 receives the evaluation result packet group 1000 from the detection result analysis unit 150, the candidate output unit 160 outputs the group 1000 to, for example, the detection device 200. The candidate output unit 160 may output the evaluation result packet group 1000 itself to the detection device 200. Alternately, the candidate output unit 160 may output to the detection device 200 only the parameters of the one or more candidate packets 500″ included in the group 1000 such as the source IP address, the source port number, the destination IP address, the destination port number, and the protocol.

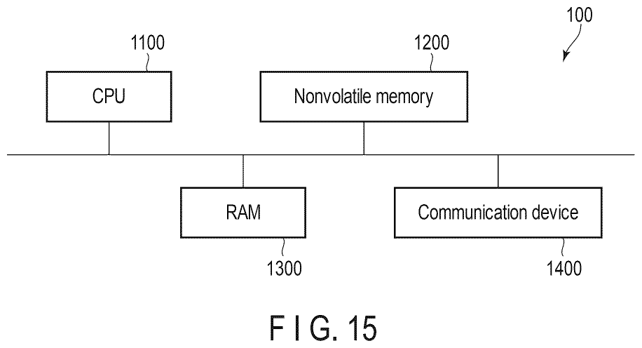

FIG. 15 shows a hardware configuration example of the information processing device 100.

As shown in FIG. 15, the information processing device 100 includes, for example, a CPU 1100, a nonvolatile memory 1200, a RAM 1300, and a communication device 1400.

The CPU 1100 is a processor that controls operations of the information processing device 100. The CPU 1100 is constituted by at least one processor. The CPU 1100 executes various programs loaded into the RAM 1300 from the nonvolatile memory 1200. These programs include an operating system (OS) and various application programs.

The nonvolatile memory 1200 is a storage medium used as an auxiliary storage device. The nonvolatile memory 1200 stores the above programs. FIG. 15 shows the nonvolatile memory 1200 alone. For example, the information processing device 100 further comprises other storage devices such as a hard disk drive (HDD) or solid-state drive (SSD).

The RAM 1300 is a storage medium used as a main storage device. The RAM 1300 may be used as a temporary storage area for data used during the processing by the information processing device 100.

The communication device 1400 performs wired or wireless communication with external devices (for example, the detection device 200, the communication acquisition device 300, or the monitored system).

Some or all of the analysis unit 110, the candidate generation unit 130, the candidate communication unit 140, the detection result analysis unit 150, and the candidate output unit 160 shown in FIG. 3 are implemented by executing predetermined programs on the CPU 1100 (that is, they are implemented as software). These programs may be stored on a computer-readable storage medium and distributed. Alternatively, these programs may be downloaded to the information processing device 100 via a network. Alternatively, some or all of the analysis unit 110, the candidate generation unit 130, the candidate communication unit 140, the detection result analysis unit 150, and the candidate output unit 160 may be implemented by dedicated hardware, or by a combination of software and hardware.

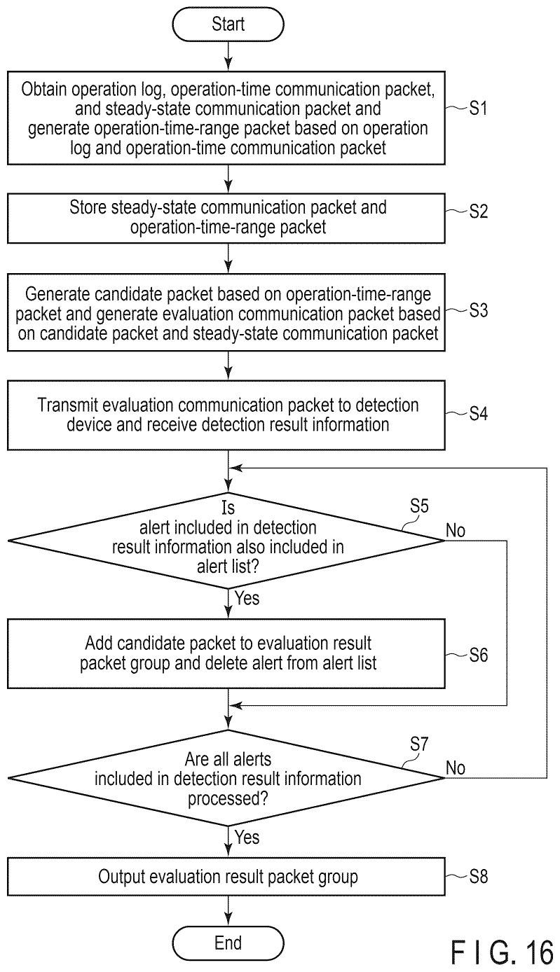

FIG. 16 is a flowchart showing an example of a sequence of processes executed by the information processing device 100 according to the present embodiment. The sequence of processes shown in FIG. 16 may be executed, for example, when the information processing device 100 acquires the alert list 900 from the detection device 200 (more specifically, the alert list 900 including a false positive alert issued by the detection device 200).

First, the analysis unit 110 of the information processing device 100 acquires the operation log 400 from the monitored system and acquires the operation-time communication packet 500 and the steady-state communication packet 600 from the communication acquisition device 300. Then, the analysis unit 110 generates the operation-time-range packet 500′, based on the acquired operation log 400 and the acquired operation-time communication packet 500 (the step S1).

The communication storage unit 120 stores both of the steady-state communication packet 600 acquired by the analysis unit 110 and the operation-time-range packet 500′ generated by the analysis unit 110 (the step S2).

The candidate generation unit 130 cuts out part of the operation-time-range packet 500′ stored in the communication storage unit 120 to generate the candidate packet 500″ and then, based on the generated candidate packet 500″ and the steady-state communication packet 600 stored in the communication storage unit 120, generates the evaluation communication packet 700 (the step S3).

The candidate communication unit 140 transmits the evaluation communication packet 700 generated by the candidate generation unit 130 to the detection device 200, and receives the detection result information 800 including one or more alerts issued from the detection device 200 as a result of reading the evaluation communication packet 700 (the step S4).

The detection result analysis unit 150 focuses on one alert among those included in the detection result information 800 received by the candidate communication unit 140 and determines whether the focused alert is included in the alert list 900 acquired from the detection device 200 (the step S5). If the alert is determined as not included in the alert list 900 through the process of the step S5 (No in the step S5), the process proceeds to the step S7 described below.

If the alert is determined as included in the alert list 900 through the process of the step S5 (Yes in the step S5), the detection result analysis unit 150 adds (collects) the candidate packet 500″, which was used to generate the evaluation communication packet 700 read by the detection device 200 to reproduce that alert, to the evaluation result packet group 1000, and deletes the alert corresponding to the focused alert from the alert list 900 (the step S6).

Next, the detection result analysis unit 150 determines whether all alerts included in the detection result information 800 received by the candidate communication unit 140 have been processed (the step S7).

If the detection result analysis unit 150 determines that not all of these alerts have been processed through the step S7 (No in the step S7), the detection result analysis unit 150 focuses on unprocessed alert in the detection result information 800 and repeats the process in the step S5.

If the detection result analysis unit 150 determines that all of these alerts have been processed through the step S7 (Yes in the step S7), the candidate output unit 160 outputs to the detection device 200 the evaluation result packet group 1000 including the collected candidate packets 500″ collected by the detection result analysis unit 150 (the step S8). The information processing device 100 then terminates the sequence of processes shown in FIG. 16.

For example, when a false positive detection occurs due to normal-range operations by an operator managing the monitored system where an NIDS capable of learning network traffic and dynamically generating rules is implemented as the detection device 200, the information processing device 100 according to the present embodiment generates the evaluation communication packet 700 based on the operation log 400 at the time of the false positive detection occurrence and the operation-time communication packet 500 that flowed through the monitored system at the time of the false positive detection occurrence, and the steady-state communication packet 600 that normally flows through the monitored system. Then, the information processing device 100 transmits this evaluation communication packet 700 to the detection device 200. The information processing device 100 compares the alert issued by the detection device 200 reading the evaluation communication packet 700 with the alert issued during the false positive detection occurrence. This comparison identifies the operation causing the false positive detection and the communication performed in response to that operation. Information about the operation and communication identified by the information processing device 100 as the cause of the false positive detection is transmitted to the detection device 200. Therefore, the detection device 200 can update the rules to prevent similar false positive detections from occurring.

The information processing device 100 generates the evaluation communication packet 700 based on the operation log 400 acquired from the monitored system and the operation communication packet 500 and the steady-state communication packet 600 acquired from the communication acquisition device 300. The information processing device 100 compares the alert reproduced by the evaluation communication packet 700 with the alert that occurred during the false positive detection to identify the operation that caused the false positive detection and the communication performed in response to that operation. Thus, the information processing device 100 can identify the cause of the false positive detection even if the communication specifications of the monitored system or the alert generation specifications of the detection device 200 are unknown.

The present embodiment described above provides an information processing device, a program, and a method capable of suppressing false positive detections that may occur when an intrusion detection system is introduced into a monitored system.

While certain embodiments have been described, these embodiments have been presented by way of example only, and are not intended to limit the scope of the inventions. These novel embodiments can be implemented in various other forms, and various omissions, substitutions, and modifications can be made to the extent that they do not depart from the gist of the invention. These embodiments and variations thereof are included in the scope and gist of the invention as well as in the claims and their equivalents.

What is claimed is

1. An information processing device communicatively connected to a detection device configured to detect cyberattacks and issue alerts, the information processing device comprising:
a candidate generation unit configured to generate a fourth communication packet for identifying a cause of a false positive detection occurring in the detection device, based on a second communication packet, which is part of a first communication packet that flowed through a monitored system monitored by the detection device upon operating one or more devices included in the monitored system and is presumed to correspond to an operation of the one or more devices, and a third communication packet that flowed through the monitored system as a result of routine communication performed in the monitored system; and
a detection result analysis unit configured to compare a first alert, which was issued when the fourth communication packet is read by the detection device, with a list of alerts previously issued from the detection device during operations of the one or more devices and, when the first alert is included in the list, to identify the second communication packet used to generate the fourth communication packet read by the detection device as the cause of the false positive detection occurring in the detection device.

2. The information processing device of claim 1, further comprising:
an analysis unit configured to, based on an operation log in which operation histories of the one or more devices are stored and the first communication packet, generate a fifth communication packet, which is part of the first communication packet and flowed through the monitored system in a communication performed around a time corresponding to the operation log, wherein
the candidate generation unit extracts part of the fifth communication packet to generate the second communication packet.

3. The information processing device of claim 2, wherein
the candidate generation unit focuses on one frame among one or more frames included in the fifth communication packet, extracts a frame indicating the same protocol as the frame focused and having the same combination of transmission source and destination as the frame focused, and generates the second communication packet including the frame extracted.

4. The information processing device of claim 3, wherein
the candidate generation unit modifies time information of the second communication packet and time information of the third communication packet and then combines the second communication packet and the third communication packet each having the time information modified to generate the fourth communication packet.

5. The information processing device of claim 1, wherein
when a plurality of first alerts are issued upon the fourth communication packet being read by the detection device, the detection result analysis unit determines whether each of the plurality of first alerts is included in the list.

6. The information processing device of claim 1, wherein
the monitored system has an unknown communication specification, and
the detection device has an unknown alert-issuing specification.

7. A non-transitory computer-readable storage medium storing instructions that, when executed by a computer of an information processing device communicably connected to a detection device that detects cyberattacks and issues alerts, cause the computer to:
generate a fourth communication packet for identifying a cause of a false positive detection occurring in the detection device, based on a second communication packet, which is part of a first communication packet that flowed through a monitored system monitored by the detection device upon operating one or more devices included in the monitored system and is presumed to correspond to an operation of the one or more devices, and a third communication packet that flowed through the monitored system as a result of routine communication performed in the monitored system; and
compare a first alert, which was issued when the fourth communication packet was read by the detection device with a list of alerts previously issued from the detection device during operations of the one or more devices and, when the first alert is included in the list, identify the second communication packet used to generate the fourth communication packet read by the detection device as the cause of the false positive detection occurring in the detection device.

8. A method executed by an information processing device communicably connected to a detection device that detects cyberattacks and issues alerts, comprising steps of:
generating a fourth communication packet for identifying a cause of a false positive detection occurring in the detection device, based on a second communication packet, which is part of a first communication packet that flowed through a monitored system monitored by the detection device upon operating one or more devices included in the monitored system and is presumed to correspond to an operation of the one or more devices, and a third communication packet that flowed through the monitored system as a result of routine communication performed in the monitored system; and
comparing a first alert, which was issued when the fourth communication packet was read by the detection device with a list of alerts previously issued from the detection device during operations of the one or more devices and, when the first alert is included in the list, identifying the second communication packet used to generate the fourth communication packet read by the detection device as the cause of the false positive detection occurring in the detection device.
